(19) United States
(12) Patent Application Publication
(10) Pub. No.: US 2016/0202525 A1
(43) Pub. Date: Jul. 14, 2016

(54) DISPLAY DEVICE

(71) Applicant: Japan Display Inc., Tokyo (JP)

(72) Inventors: Chihiro Tanaka, Tokyo (JP); Koji Noguchi, Tokyo (JP); Naosuke Furutani, Tokyo (JP); Toshihiko Tanaka, Tokyo (JP)

(21) Appl. No.: 14/992,662

(22) Filed: Jan. 11, 2016

(30) Foreign Application Priority Data
Jan. 14, 2015 (JP) 2015-005342
Mar. 27, 2015 (JP) 2015-066719

(51) Int. Cl. G02F 1/1333; G02F 1/1343; G02F 1/1335

(52) U.S. Cl. CPC G02F 1/13338; G02F 1/133528; G02F 1/134309; G02F 1/133345

(57) ABSTRACT

According to one embodiment, a display device includes a display panel including a first surface and a second surface on an opposite side to the first surface, configured to display an image on the second surface, a cover glass includes a third surface and a fourth surface on an opposite side to the third surface, the third surface facing the second surface of the display panel, an adhesive layer configured to fix the display panel and the cover glass to each other and an optical film fixed to the fourth surface of the cover glass.

### CROSS REFERENCES TO RELATED APPLICATIONS

This application is based upon and claims the benefit of priority from Japanese Patent Applications No. 2015-005342, filed Jan. 14, 2015; and No. 2015-066719, filed Mar. 27, 2015, the entire contents of all of which are incorporated herein by reference.

### FIELD

Embodiments described herein relate generally to a display device.

### BACKGROUND

In recent years, display devices with a touch panel (touch sensor) to detect contact or approach of an object have been put to practical use. As an example, a display panel including touch panel provided thereon is disclosed. The display panel comprises a detection electrode and a drive electrode which form a capacitance therebetween to detect an input position.

As described above, if a cover glass is provided on the surface of the display device, it is possible that the cover glass will be broken and the broken pieces will be scattered. On the other hand, if the cover glass is omitted and an optical film (polarizer) is attached to the surface of the display device, the display device may warp when an object comes into contact with it, causing a localized change in phase difference. Thus, non-uniformity of display may occur around the region where the object contacts.

Additional features and advantages are described herein, and will be apparent from the following Detailed Description and the figures.

### SUMMARY

The present disclosure generally relates to a display device.

In an embodiment, a display device is provided including a display panel including a first surface and a second surface on an opposite side to the first surface, configured to display an image on the second surface; a cover glass comprising a third surface and a fourth surface on an opposite side to the third surface, the third surface facing the second surface of the display panel; an adhesive layer configured to fix the display panel and the cover glass to each other; and an optical film fixed to the fourth surface of the cover glass.

In an embodiment, the display panel includes a first substrate, a second substrate opposing the first substrate and a liquid crystal layer held between the first substrate and the second substrate, and the optical film comprises a polarizer.

In an embodiment, the first substrate includes a pixel electrode provided for every pixel on a side opposing the second substrate, a common electrode opposing a plurality of pixel electrodes, and an interlayer insulating film interposed between the pixel electrodes and the common electrode.

In an embodiment, the display device further includes a detection electrode between the display panel and the cover glass, configured to detect an object approaching or contacting the optical film.

In an embodiment, the display device further includes an antistatic layer between the display panel and the cover glass.

In an embodiment, the antistatic layer is formed on the second or third surface.

In an embodiment, the adhesive layer is an antistatic layer.

In an embodiment, the antistatic layer has a sheet resistance of 10⁸Ω/□ or more.

In an embodiment, the display device further includes a detection electrode configured to detect an object approaching or contacting the optical film, and an antistatic layer, between the display panel and the cover glass, wherein more, the detection electrode has a sheet resistance value of 1/100 or less of that of the antistatic layer.

In an embodiment, the cover glass is formed from untempered glass.

Additional features and advantages are described herein, and will be apparent from the following Detailed Description and the figures.

### BRIEF DESCRIPTION OF THE FIGURES

FIG. 1 is a perspective view showing the structure of a display device DSP according to this embodiment.

FIG. 2 is a sectional view showing a part of the structures of the display device DSP shown in FIG. 1.

FIG. 3 is a diagram showing an example of the structure of the display device DSP according to this embodiment.

FIG. 4 is a sectional view showing the structure of the display panel shown in FIG. 2.

FIG. 5 is a diagram showing a process flow of manufacturing the display device DSP having the section shown in FIG. 2 (a).

FIG. 6 is a diagram showing a process flow of manufacturing the display device DSP having the section shown in FIG. 2 (b).

FIG. 7 is a diagram showing a process flow of manufacturing the display device DSP having the section shown in FIG. 2 (c).

FIG. 8 is a diagram showing a process flow of manufacturing the display device DSP having the section shown in FIG. 2 (d).

### DETAILED DESCRIPTION

In general, according to one embodiment, a display device comprises a display panel comprising a first surface and a second surface on the opposite side to the first surface, configured to display an image on the second surface; a cover glass comprising a third surface and a fourth surface on the opposite side to the third surface, the third surface facing the second surface of the display panel; an adhesive layer configured to fix the display panel and the cover glass to each other and an optical film fixed to the fourth surface of the cover glass.

Embodiments will be described hereinafter with reference to the accompanying drawings. Incidentally, the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc. of the respective parts are schematically illustrated in the drawings, compared to the actual modes. However, the schematic illustration is merely an example, and adds no restrictions to the interpretation of the invention. Besides, in the specification and drawings, the structural elements having functions, which are identical or similar to the functions of the structural elements described in connection with preceding drawings, are denoted by like reference numbers, and an overlapping detailed description is omitted unless otherwise necessary. Also note that the expression “provided on”, “located on”, or the like used in this specification is meant both states that a member is directly in contact, and it is provided indirectly via another member.

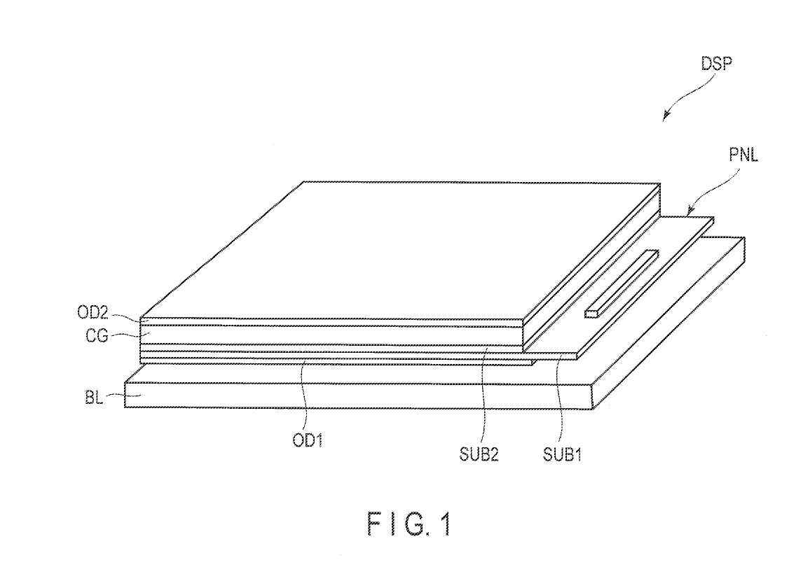

FIG. 1 is a perspective view showing the structure of the display device DSP according to this embodiment. Note that this embodiment will be described in connection with a liquid crystal display as an example of the display device. The display device can be used for various devices such as smartphones, tablets, mobile phone units, personal computers, television receivers, in-vehicle devices and games consoles. Further, the main structures described in connection with this embodiment are applicable to an auto-luminescent display device comprising an organic electroluminescent display element or the like, an electronic-paper display device having an electrophoretic element or the like, a display device adopting micro-electromechanical systems (MEMS) or a display device adopting electrochromism.

The display device DSP comprises a display panel PNL, a backlight unit BL to illuminate the display panel PNL, a cover glass CG, a first optical film OD1, a second optical film OD2 and the like. The display device DSP has a touch detection function.

The display panel PNL comprises a first substrate SUB1, a second substrate SUB2 provided to oppose the first substrate SUB1, a liquid crystal layer (liquid crystal layer LC, explained later) interposed between the first substrate SUB1 and the second substrate SUB2. The display panel PNL is of a transmission type having a transmission display function of transmitting light from the backlight unit BL selectively to display images. Note that, besides the transmission type, the display panel PNL may be of a reflective type having a reflective display function of reflecting the light from the display surface side, such as external light or fill light to display images. Further, the display panel PNL may be of a semi-transmission type having the transparent display function and the reflective display function.

The backlight unit BL is arranged on a side opposing the first substrate SUB1 of the display panel PNL. As such the backlight unit BL, various types are applicable. Moreover, as the light source, various types including a light-emitting diode (LED) and a cold cathode fluorescent lamp (CCFL) are applicable. Here, detailed explanations on these structures are omitted. In addition, when the display panel PNL is a reflective type having solely the reflective display function, the backlight unit BL is omitted.

A cover glass CG is arranged on a side opposing the second substrate SUB2 of the display panel PNL. A first optical film OD1 and a second optical film OD2 are provided so as to interpose the display panel PNL and the cover glass CG therebetween. More specifically, the first optical film OD1 is situated between the first substrate SUB1 and the backlight unit BL. For example, the first optical film OD1 is fixed to the first substrate SUB1. The second optical film OD2 is situated on a side of the cover glass CG, which is opposite to the side facing the display panel PNL. That is, the second optical film OD2 is provided on the surface of the display device DSP. For example, the second optical film OD2 is fixed to the cover glass CG. The first optical film OD1 and the second optical film OD2 each comprise a polarizer, and also may include, if necessary, some other optical films such as a retardation film and a viewing-angle expansion film.

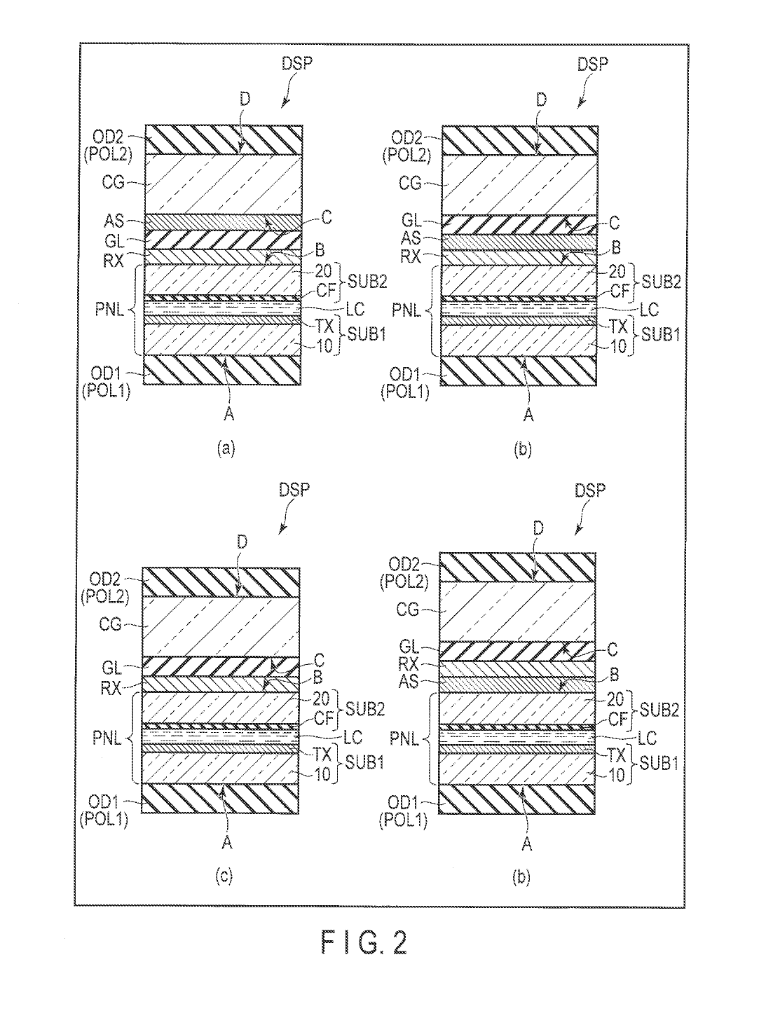

FIG. 2 is a sectional view showing a part of the structures of the display device DSP shown in FIG. 1.

As shown in FIG. 2 (a), the display device DSP comprises the display panel PNL, a detection electrode RX, an adhesive layer GL, an antistatic layer AS, the cover glass CG, the first optical film OD1 and the second optical film OD2.

The display panel PNL comprises the first substrate SUB1, the second substrate SUB2 opposing the first substrate SUB1 and a liquid crystal layer LC provided between the first substrate SUB1 and the second substrate SUB2. The first substrate SUB comprises a first insulating substrate 10, a drive electrode TX and the like. The second substrate SUB2 comprises a second insulating substrate 20, a color filter CF and the like. The display panel PNL comprises a surface A, which is the first surface, and a surface B, which is the second surface opposite to the surface A. The surface B of the display panel PNL is equivalent to the display surface configured to display images. A detailed explanation of the structure of the display panel PNL will be provided later.

The drive electrode TX is used for touch detection and can also function as a common electrode for display. In a mutual detection system, the detection electrode RX is disposed to oppose the drive electrode TX and configured to output signals regarding touch. Or in a self detection system, either one of the detection electrode RX and the drive electrode TX may be omitted and the panel may be configured to perform touch detection with an electrode of the same layer.

The cover glass CG comprises a surface C, which is the third surface, and a surface D, which is the fourth surface on the opposite side to the surface C. The surface B of the display panel PNL and the surface C of the cover glass CG oppose each other. The cover glass CG is a transparent glass board formed thicker than the first insulating substrate 10 and the second insulating substrate 20. For example, the cover glass CG has a thickness of about 1 mm, whereas the first insulating substrate 10 and the second insulating substrate 20 have a thickness of about 0.1 to 0.6 mm. For example, when display device DSP is applied to an in-vehicle device, the first insulating substrate 10 and the second insulating substrate 20 have a thickness of about 0.5 to 0.6 mm. Or when display device DSP is applied to a mobile device, the first insulating substrate 10 and the second insulating substrate 20 have a thickness of about 0.1 to 0.2 mm.

The cover glass CG is formed from tempered glass, which has been subjected to a treatment of improving the breakdown resistance, or untempered glass. Examples of the tempered glass are physically reinforced glass, on a glass surface of which a compressive stress layer is formed, and chemically strengthened glass. The compressive stress layer has compressive stress which acts against the tensile stress, which may cause the glass to crack. The compressive stress layer of the physically strengthened glass is prepared by heating the glass to near its softening temperature, followed by quick cooling, and the thickness thereof is about one fifth that of the glass. The compressive stress value of the physically strengthened glass is, for example, about 100 to 150 MPa. The compressive stress layer of the chemically strengthening glass is prepared by putting soda lime glass in a melting bath of potassium nitrate at a temperature of 300 to 500° C. to substitute sodium ions contained in the glass surface with potassium ions in the melting bath. The compressive stress value of the chemically strengthened glass is, for example, 300 to 800 MPa, but the compressive stress layer of the chemically strengthened glass is formed thinner as compared to that of the physically strengthened glass. For example, the thickness of the compressive stress layer of the chemically strengthened glass is about 10 to 100 μm. The physical strengthening is suitable for glass materials of simple shapes having a thickness more than or equal to about 3 mm, for example. The chemical strengthening is applicable regardless of the shape or thickness of the glass material. Therefore, in the display device DSP, which requires to be slimmed down, it is more desirable to apply chemically strengthened glass as the cover glass CG.

On the other hand, the untempered glass is a glass material which has not been subjected to a treatment as with the tempered glass, and is inexpensive as compared to the tempered glass. As compared to chemically strengthened glass, there are rarely potassium ions on the surface of untempered glass (or more sodium ions are present than potassium ions). Further, untempered glass hardly includes a compressive stress layer on the surface thereof, and the strength is about 50 MPa. Note that the depth and the compressive stress value of a compressive stress layer can be measured using a surface stress measurement device (for example, Surface Stress Meter FSM-6000 of Orihara Manufacturing Co., Ltd.).

The detection electrode RX is situated between the display panel PNL and the cover glass CG. In the illustrated example, the detection electrode RX is formed on the surface B of the display panel PNL. The detection electrode RX has a function of detecting an object approaching or contacting the second optical film OD2. The detection electrode RX is formed from a transparent conductive material such as indium-tin-oxide (ITO) and indium-zinc-oxide (IZO), or a thin metal wire of aluminum, titanium, molybdenum, tungsten or the like.

An antistatic layer AS is situated between the display panel PNL and the cover glass CG. In the illustrated example, the antistatic layer AS is formed on the surface C of the cover glass CG. The antistatic layer AS is formed from a transparent conductive material such as ITO or IZO. The antistatic layer AS has a resistance higher than the detection electrode RX, and is formed of, for example, a material having a sheet resistance of 10⁸Ω/□ or more, or more preferably, of a material having a sheet resistance of about 10⁹ to 10¹¹Ω/□. Note that the sheet resistance value of the detection electrode RX should desirably be 1/100 or less of the sheet resistance value of the antistatic layer AS. For example, the detection electrode RX has a sheet resistance value of several tens to several hundreds of Ω/□. With this structure, according to the embodiment in which the detection electrode RX and the antistatic layer AS are in contact with each other, the detection electrode RX is able to operate normally, making it possible to release accumulated charge externally through the detection electrode RX.

The adhesive layer GL fixes the display panel PNL and the cover glass CG to each other. In the illustrated example, the adhesive layer GL is situated between the antistatic layer AS and the detection electrode RX. The adhesive layer GL is formed of a transparent organic material or the like, for example, a photocuring or thermosetting resin material. Note that the adhesive layer GL may be electrically conductive, in which case it also functions as an antistatic layer.

The first optical film OD1 comprises a first polarizer POL1, and is fixed to the surface A of the display panel PNL. The second optical film OD2 comprises a second polarizer POL2, and is fixed to the surface D of the cover glass CG.

As compared to that of FIG. 2 (a), the structure shown in FIG. 2 (b) differs in the way of arranging the adhesive layer GL and the antistatic layer AS. More specifically, the antistatic layer AS is located on the detection electrode RX. The adhesive layer GL is situated between the surface C of the cover glass CG and the antistatic layer AS. The detection electrode RX and the antistatic layer AS are in contact with each other, but as explained above, the antistatic layer AS has a resistance sufficiently higher rather than the detection electrode RX; therefore, the detection of an object by the detection electrode RX is not affected.

The structure shown in FIG. 2 (c) differs in that an antistatic layer AS is not formed as compared to that of FIG. 2 (a). More specifically, the adhesive layer GL is situated between the surface C of the cover glass CG and the detection electrode RX. In this case, it is desirable for the adhesive layer GL to have a sheet resistance equivalent to that of the antistatic layer AS. That is, it is desirable for the adhesive layer GL to function as an antistatic layer AS.

As compared to that FIG. 2 (a), the structure shown in FIG. 2 (d) differs in the arrangement of the detection electrode RX, the adhesive layer GL and the antistatic layer AS. More specifically, the antistatic layer AS is formed on the surface B of the display panel PNL. The detection electrode RX is stacked on the antistatic layer AS. The adhesive layer GL is situated between the surface C of the cover glass CG and the detection electrode RX.

Note that in the structures shown in FIGS. 2 (a), (b) and (d), the adhesive layer GL may be omitted. For example, when the adhesive layer GL is omitted, the detection electrode RX and the antistatic layer AS are mutually fixed in the structure shown in FIG. 2 (a); the antistatic layer AS and the cover glass CG are mutually fixed in the structure shown in FIG. 2 (b); and the detection electrode RX and the cover glass CG are mutually fixed in the structure shown in FIG. 2 (d). Further, in the structures shown in FIGS. 2 (a), (b) and (d), the adhesive layer GL may be substituted by an air layer. Furthermore, in the structures shown in FIGS. 2 (a), (b), (c) and (d), the detection electrode RX need not be provided.

Moreover, the antistatic layer AS may be made to float or fixed to a predetermined potential such as ground potential.

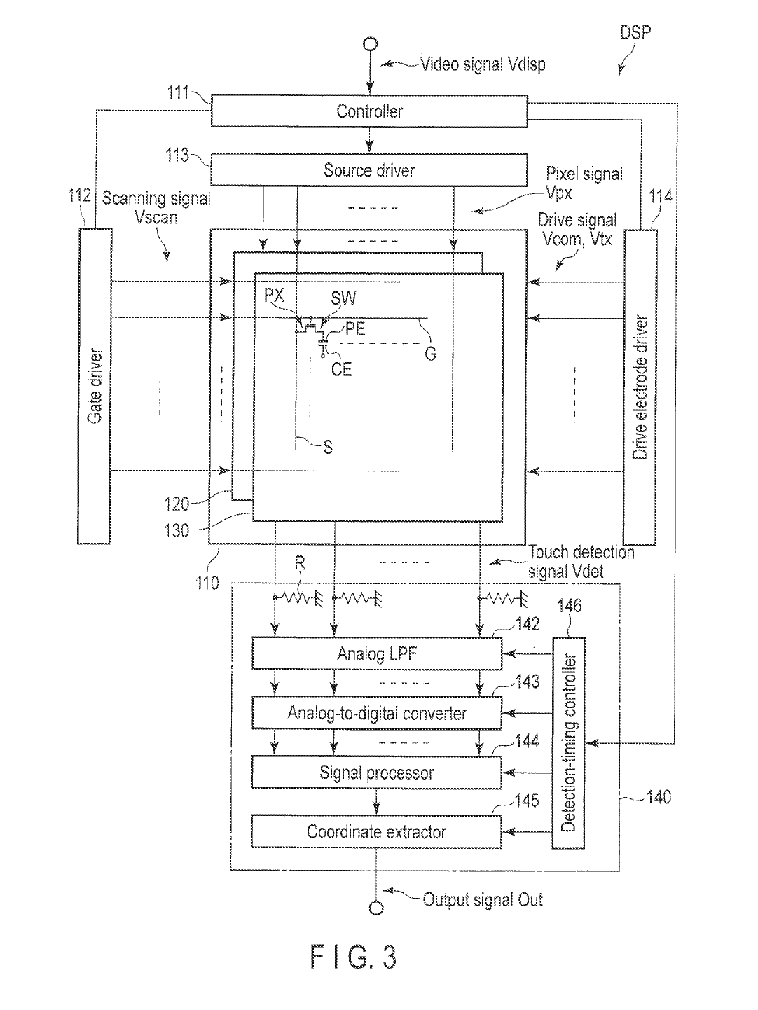

FIG. 3 is a diagram showing an example of the structure of the display device DSP to according to this embodiment.

The display device DSP comprises a controller 111, a gate driver 112, a source driver 113, a drive electrode driver 114, a touch detection display device 110 and a touch detection unit 140.

Based on an externally supplied video signal Vdisp, the controller 111 supplies control signals to the gate driver 112, the source driver 113, the drive electrode driver 114 and the touch detection unit 140, respectively, and is equivalent to a circuit to control these members to operate in synchronization with each other.

The gate driver 112 has a function of selecting each one row of pixels PX to be driven for display on the touch detection display device 110 sequentially based on the control signals supplied from the controller 111. The source driver 113 is equivalent to a circuit to supply pixel signals Vpx to each pixel PX of the touch detection display device 110 based on the control signals supplied from the controller 111. The drive electrode driver 114 is a circuit to supply sensor driving signals Vtx or common driving signals Vcom to the drive electrode TX (or common electrode CE) of the touch detection display device 110 based on the control signals supplied from the controller 111.

The touch detection display device 110 is a display device with an intrinsic touch detection function. The touch detection display device 110 comprises a liquid crystal display device 120 provided with a liquid-crystal-display element as a display element and a capacitive touch detection device 130. The liquid crystal display device 120 and the touch detection device 130 are integrated with each other. In addition, the liquid crystal display device 120 contains the display panel PNL shown in FIG. 2, and the touch detection device 130 contains the detection electrode RX shown in FIG. 2.

The liquid crystal display device 120 comprises a gate line G electrically connected to the gate driver 112, a source line S electrically connected to the source driver 113, a switching element SW electrically connected to the gate line G and the source line S in a pixel PX, a pixel electrode PE electrically connected to the switching element SW and a common electrode CE opposing the pixel electrode PE.

First, the operation for displaying images in the liquid crystal display device 120 will be briefly described. The gate driver 112 applies a scanning signal Vscan to the gate electrode of the switching element SW of each respective pixel PX through the gate line G. Thus, one horizontal line equivalent to one row of pixels PX formed in matrix in the liquid crystal display device 120 are selected sequentially as objects to be driven for display. The source driver 113 supplies a pixel signal Vpx to each of pixels PX of one horizontal line selected sequentially by the gate driver 112 through the respective source line S. The drive electrode driver 114 supplies the common driving signal Vcom to the common electrode CE. Each pixel PX is driven according to the potential difference between the pixel signal Vpx and the common driving signal Vcom, and thus those pixels PX of one horizontal line are driven.

Next, the touch detection of the liquid crystal display device 120 will be briefly described. The drive electrode driver 114 applies the sensor driving signal Vtx to each drive electrode TX sequentially in a time-sharing manner. The touch detection device 130 outputs touch detection signals Vdet from a plurality of sensing electrodes RX based on the sensor driving signal Vtx and supplies the signals to the touch detection unit 140. Whether or not a touch has been detected based on the touch detection signals Vdet is determined by the touch detection unit 140, described later. The sensing electrodes RX are grounded at a predetermined impedance R. Note that the sensing electrodes RX may not be grounded at a predetermined impedance R.

The touch detection unit 140 is configured to detect touching of the touch detection device 130 based on the control signal supplied from the controller 111, and the touch detection signal Vdet supplied from the touch detection device 130 of the touch detection display device 110. If the touch detection device 130 has been touched, the touch detection unit 140 computes the coordinates or the like in the touch detection region. The touch detection unit 140 comprises an analog low-pass filter (LPF) 142, an analog-to-digital (A/D) converter 143, a signal processor 144, a coordinate extractor 145, and a detection-timing controller 146.

The analog LPF section 142 is a low-pass analog filter which removes high frequency components (noise components) contained in the touch detection signal Vdet supplied from the touch detection device 130, and extracts the touch components to be output. Between each input terminal of the analog LPF 142 and ground, a resistance R is connected to provide a DC potential (0 V). Note that, for example, a switch may be provided in place of the resistance R. Thus, a DC potential (0 V) may be provided by setting the switch into ON state at a predetermined time.

The A/D converter 143 is a circuit to sample analog signals output from the analog LPF 142, respectively, at timings in sync with the sensor driving signals Vtx and digitize them. The signal processor 144 is a logic circuit to detect touching of the touch detection device 130 based on the output of the A/D converter 143. The coordinate extractor 145 is a logic circuit to calculate the coordinates of a touch on the panel when the touch is detected by the signal processor 144. The detection-timing controller 146 is configured to control these circuits to operate in sync with each other.

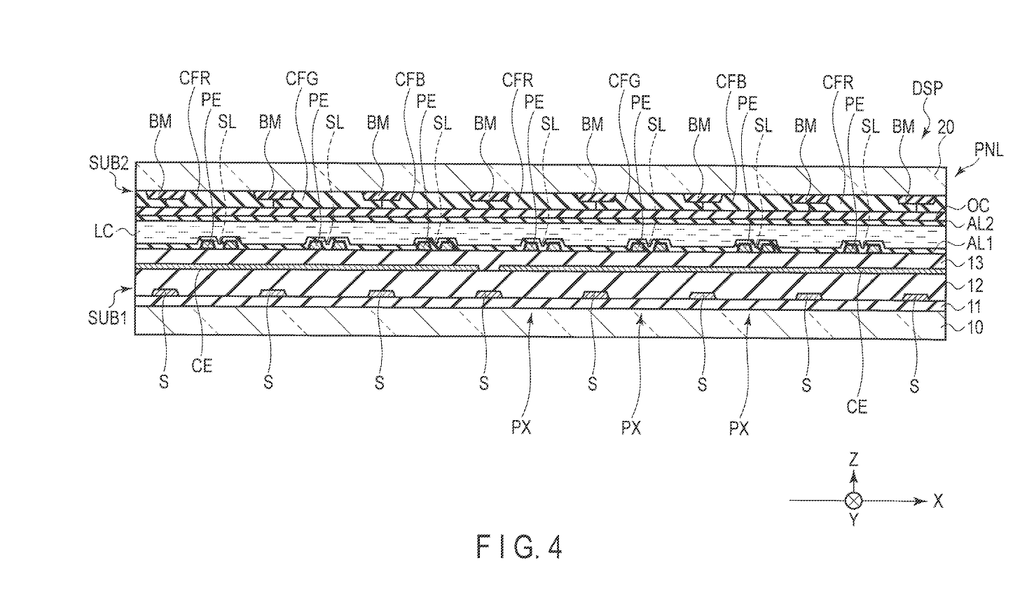

FIG. 4 is a sectional view showing the structure of the display panel PNL shown in FIG. 2.

The display panel PNL comprises the first substrate SUB1, the second substrate SUB2 and the liquid crystal layer LC. The first substrate SUB1 and the second substrate SUB2 are fixed to each other while a predetermined gap is formed therebetween. The liquid crystal layer LC is sealed in the gap between the first substrate SUB1 and the second substrate SUB2.

The first substrate SUB1 is formed using the first insulating substrate 10 having light transmissivity, made of, for example, a glass substrate, a resin substrate or the like. The first substrate SUB1 comprises, on a side of the first insulating substrate 10, which opposes the second substrate SUB2, source lines S, a common electrode CE, pixel electrodes PE, the first insulating film 11, the second insulating film 12, the third insulating film 13, a first alignment film AL1 and the like, in addition to the gate lines and switching elements, which are not shown.

The first insulating film 11 is provided on the first insulating substrate 10. The source lines S are formed on the first insulating film 11. Further, the source electrodes, drain electrodes and the like, of the switching elements are formed on the first insulating film 11.

The second insulating film 12 is provided on the source lines S and the first insulating film 11. The common electrode CE is provided over a plurality of pixels PX and formed on the second insulating film 12. The common electrode CE is equivalent to the drive electrode TX shown in FIG. 2.

The third insulating film 13 is provided on the common electrode CE and the second insulating film 12. The pixel electrodes PE are provided for the respective pixels PX and are formed on the third insulating film 13. Each pixel electrode PE is situated between a adjacent pair of respective source lines S to oppose the common electrode CE. Further, each pixel electrode PE has a slit SL in a position opposing the common electrode CE. The pixel electrodes PE and the common electrode CE are each formed from a transparent conductive material such as ITO or IZO. The first alignment film AL1 covers the pixel electrodes PE and the third insulating film 13.

On the other hand, the second substrate SUB2 is formed using the second insulating substrate 20 having light transmissivity, made of, for example, a glass substrate, a resin substrate or the like. The second substrate SUB2 comprises, on a side of the second insulating substrate 20, which opposes the first substrate SUB1, a light-shielding layer BM, color filters CFR, CFG and CFB, an overcoat layer OC, a second alignment film AL2 and the like.

The light-shielding layer BM is formed on an inner side of the second insulating substrate 20 so as to partition each pixel. The color filters CFR, CFG and CFB are formed on the inner side of the second insulating substrate 20 so as to partially overlap the light shielding layer BM. The color filter CFR is a red filter provided in a red pixel and formed of a red resin material. The color filter CFG is a green filter provided in a green pixel and formed of a green resin material. The color filter CFB is a blue filter provided in a blue pixel and formed of a blue resin material. The example illustrated corresponds to the case where the unit pixel, which is the minimum unit of a color image comprising three color pixels of red, green and blue. Note that the unit pixel is not limited to the combination of the three color pixels described above. For example, the unit pixel may comprise four color pixels of red, green, blue and white. In this case, a white or transparent color filter may be provided in a white pixel, or the color filter itself of the white pixel may be omitted. The overcoat layer OC covers the color filters CFR, CFG and CFB. The overcoat layer OC is formed of a transparent resin material. The second alignment film AL2 covers the overcoat layer OC.

In the display panel PNL illustrated, the first substrate SUB1 comprises both the pixel electrodes PE and the common electrode CE, whose structure corresponds mainly to the mode which utilizes a lateral electric field substantially parallel to the major surface of the substrate. Note that the structure of the display panel PNL is not limited to that of the illustrated example. For example, the display panel PNL may have a structure corresponding mainly to the display mode which utilizes a vertical electric field produced in a direction crossing the major surface of the substrate. In the display mode using the vertical electric field, such a structure is applicable that the first substrate SUB1 comprises the pixel electrodes PE, whereas the second substrate SUB2 comprises the common electrode CE. Here, the major surface of the substrate is a surface parallel to an X-Y plane defined by the first direction X and the second direction Y orthogonal to each other.

According to this embodiment, the second optical film OD2 is provided on the surface D of the cover glass CG. In other words, the second optical film OD2 is arranged on the surface of the display device DSP. With this structure, even if a shock is applied on the display device DSP and the cover glass CG is broken, it is possible to avoid the broken pieces of the cover glass CG from scattering to the side of the observer watching the display device DSP. Further, since the broken cover glass CG is covered by the second optical film OD2, it is possible to avoid the broken pieces of the cover glass CG from being exposed to the side of the observer. Furthermore, the optical films, which are components of the display device, can also serve to avoid scattering of broken cover glass CG, and therefore there is no need to provide an additional member to prevent the scattering of broken cover glass CG. Moreover, untempered glass, which is inexpensive, can be used for the cover glass CG, making it possible to lower the production cost.

As for the display device DSP which has the function to detect an object approaching or contacting, since the display panel PNL is supported by the cover glass CG on its display surface side, it is possible to prevent deformation of the display panel such as bending, which may occur when an object contacts the surface of the display device DSP. Thus, adverse effects, for example, a regional change in phase difference, which may occur in the display device DSP, can be suppressed, making it possible to inhibiting the occurrence of non-uniformity of the display near where an object has contacted the panel. Therefore, it is possible to suppress degradation of the display quality.

Moreover, the second optical film OD2 is fixed to the fourth surface D of the cover glass CG and is not brought into contact with the adhesive layer GL. With this structure, the second optical film OD2 is never contaminated by the adhesive layer GL, deteriorated by a chemical change, or damaged. Therefore, there may be a wider selection of materials which constitute the second optical film OD2, enabling to prepare it from a more inexpensive material. Further, it is no longer necessary to consider the degradation and the like of the second optical film OD2, there may be a wider selection of materials which constitute the adhesive layer GL, enabling to prepare it from a more inexpensive material.

Furthermore, according to this embodiment, the cover glass CG situated on the display surface side with respect to the detection electrode RX has a thickness of about 1 mm. With this structure, even if exposed to electrostatic discharge from the second optical film OD2 side, the static electricity disperses in the surface direction of the cover glass CG before it enters the cover glass CG in its thickness direction. Even if the static electricity reaches the detection electrode RX through the cover glass CG, it disperses in the surface direction of the detection electrode RX. Thus, it is possible to inhibit static electricity from reaching the display panel PNL. Consequently, it is possible to prevent damaging of the detection electrode RX, circuits or the like mounted on, connected to or built in the display panel PNL.

Next, the process of manufacturing the display device DSP will be described.

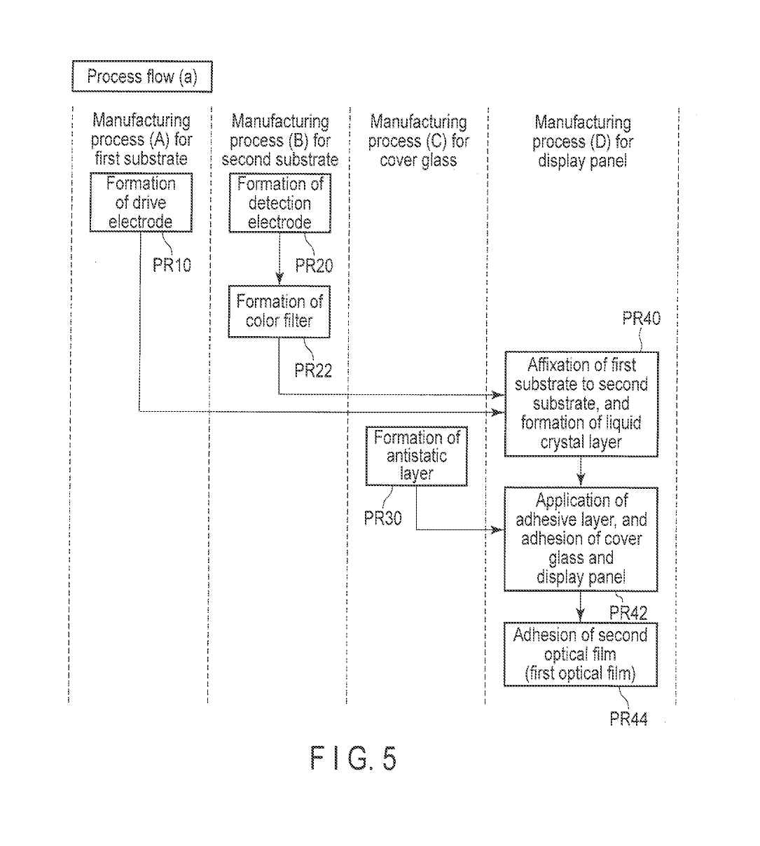

FIGS. 5 to 8 are diagrams showing process flows for manufacturing the display device DSP having cross sections shown in FIG. 2 (a) to (d), respectively. Here, the illustrated processing steps will be described, but detailed explanations for the other steps will be omitted.

FIG. 5 is a diagram showing process flow (a) for manufacturing the display device DSP which has the cross section shown in FIG. 2 (a). First, the manufacturing process (A) for the first substrate SUB1, shown in FIG. 5, will be described. As shown in FIG. 4, the first insulating film 11, the source lines S, the second insulating film 12 and the like are formed sequentially on the first insulating substrate 10. Note that the gate lines and the switching elements (not shown) are formed before the formation of the second insulating film 12. Then, the drive electrodes TX are formed in a process PR10. That is, an ITO film is formed by sputtering on the second insulating film 12, and then a resist is applied on the ITO film, followed by patterning of the resist by mask exposure. After that, the ITO film is etched using the resist as a mask and the resist is detached. Thus, the drive electrodes TX of a desired pattern are formed. After the process PR10, the third insulating film 13, the pixel electrodes PE, the first alignment film AL1 and the like are formed, and thus the first substrate SUB1 is manufactured.

Next, the manufacturing process (B) for the second substrate SUB2 shown in FIG. 5 will be described. In process PR20, the detection electrodes RX are formed on the surface B of the second insulating substrate 20. That is, an ITO film is formed by sputtering on the surface B of the second insulating substrate 20, and then patterned as in the case of the drive electrodes TX described above, thereby forming the detection electrode RX of a desired pattern. After that, the light shielding layer BM is formed on a surface opposite to the surface B of the second insulating substrate 20. Then, a color filter CF is formed in process PR22. That is, a resin film colored red, a resin film colored green, a resin film colored blue and the like are applied by a spin coat method and then patterned into desired forms. Thus, the color filter CF is formed. After the process PR22, the overcoat layer OC and the second alignment film AL2 are formed, and thus the second substrate SUB2 is manufactured. In the manufacturing process (B) of the second substrate SUB2, it is desirable to precede the formation of the detection electrodes RX, which is of a conducting film, in order to suppress the electrostatic charge on the substrate. Note that when manufacturing a thin display device DSP, for example, the first substrate SUB1 and the second substrate SUB2 are fixed to each other, and then the surfaces of the first insulating substrate 10 and the second insulating substrate 20 are polished. When manufacturing a display device DSP through such a polishing process, a conducting film is formed on the surface B and the detection electrodes RX are formed after the polishing in the process PR20.

Next, as shown in the manufacturing process (C) of the cover glass CG, an ITO film is formed by sputtering as an antistatic layer AS on the surface C of the cover glass CG in process PR30.

Next, as shown in the manufacturing process (D) of the display panel PNL, the first substrate SUB1 and the second substrate SUB2 are fixed to each other with a sealant and a liquid crystal layer LC is formed between the first substrate SUB1 and the second substrate SUB2 in process PR40. Here, the liquid crystal layer LC may be formed by an instillation method or a vacuum injection method.

When an instillation method is applied, first, a sealant is applied in a loop shape on the first substrate SUB1 or the second substrate SUB2 using a dispenser or a screen printing plate. Then, in a vacuum, a liquid crystal material is dropped in an inner region surrounded by the sealant. After that, the second substrate SUB2 is fixed to the first substrate SUB1 in a vacuum, and then atmospheric air is introduced to the vacuum. Here, because of the pressure difference between the external and internal pressures of the region between the first substrate SUB1 and the second substrate SUB2, the sealant is crushed, and thus the liquid crystal material spreads out between the first substrate SUB1 and the second substrate SUB2. In this manner, the liquid crystal layer LQ is formed in a predetermined cell gap. Subsequently, the sealant is cured by being irradiated with ultraviolet light or heated.

When a vacuum injection method is applied, first, a sealant is applied to the first substrate SUB1 or the second substrate SUB2 using a dispenser or screen printing plate. Here, the sealant is applied so as to form an inlet to inject liquid crystal. Then, the first substrate SUB1 and the second substrate SUB2 are fixed to each other, and the sealant is cured by being irradiated with ultraviolet rays or heated. After that, the internal space between the first substrate SUB1 and the second substrate SUB2 is evacuated and a liquid crystal material is poured in from the liquid crystal inlet. Subsequently, the opening of the liquid crystal inlet is sealed with a sealing agent.

The above-described process corresponds to process PR40.

In the case where a first motherboard in which a plurality of first substrates SUB1 are collectively formed, and a second motherboard in which a plurality of second substrates SUB2 are collectively formed, are applied, the first motherboard and the second motherboard are fixed together, and then cut, to manufacture display panels PNL. Note here that first, the first motherboard and the second motherboard may be cut, and then each single piece of the first substrate and each respective single piece the second substrate may be fixed to each other.

Next, in process PR42, the adhesive layer GL is applied to fix the cover glass CG and the display panel PNL to each other. The adhesive layer GL may be applied either to the antistatic layer AS of the cover glass CG or to the detection electrode RX of the display panel PNL.

Next, in process PR44, the second optical film OD2 is fixed to the surface D of the cover glass CG. Note that the first optical film OD1 may be fixed in process PR44 or in some prior or subsequent process.

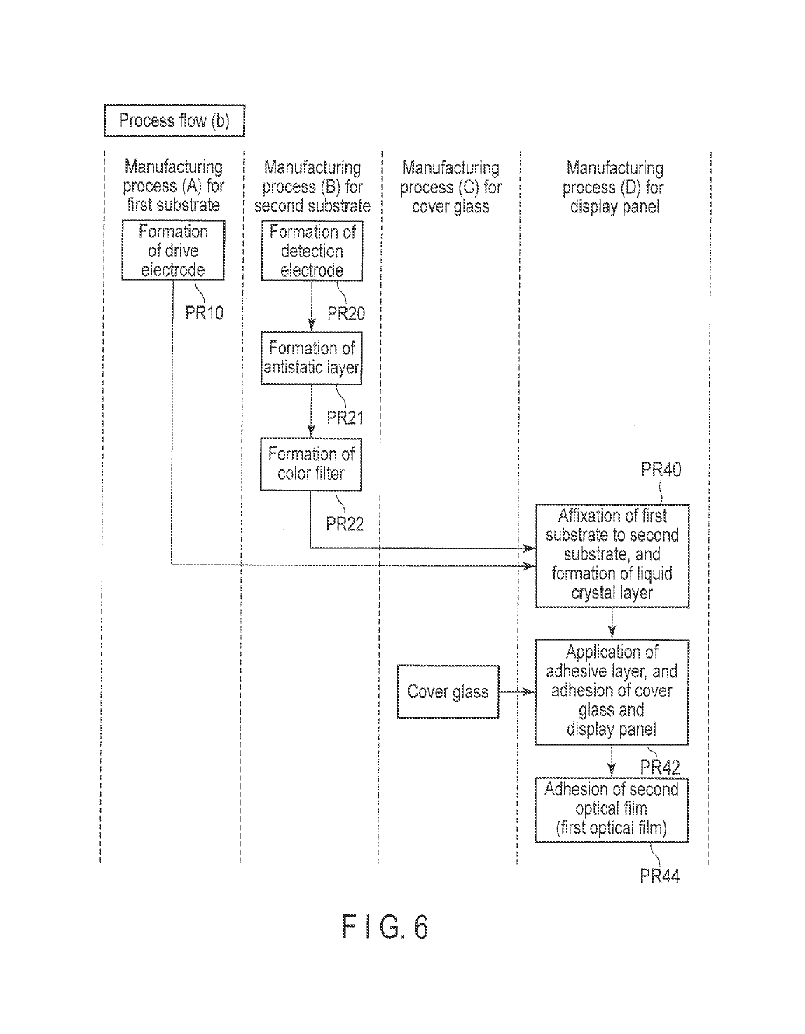

FIG. 6 is a diagram showing the process flow (b) for manufacturing the display device DSP having the cross section shown in FIG. 2 (b).

As compared to the process flow (a) shown in FIG. 5, process flow (b) differs in that the formation of the antistatic layer AS in process PR21 is carried out in the manufacturing process (B) of the second substrate SUB2 in place of the formation of the antistatic layer AS in the process PR30 in the manufacturing process (C) of the cover glass CG. As to the method of forming the antistatic layer AS in process PR21, the above-described process PR30 of FIG. 5 should be referred to. The process PR21 is performed after the process PR20. In other words, the antistatic layer AS is formed on the detection electrode RX.

Note that, in process PR42, the adhesive layer GL may be applied either to the antistatic layer AS of the cover glass CG or to the surface B of the display panel PNL.

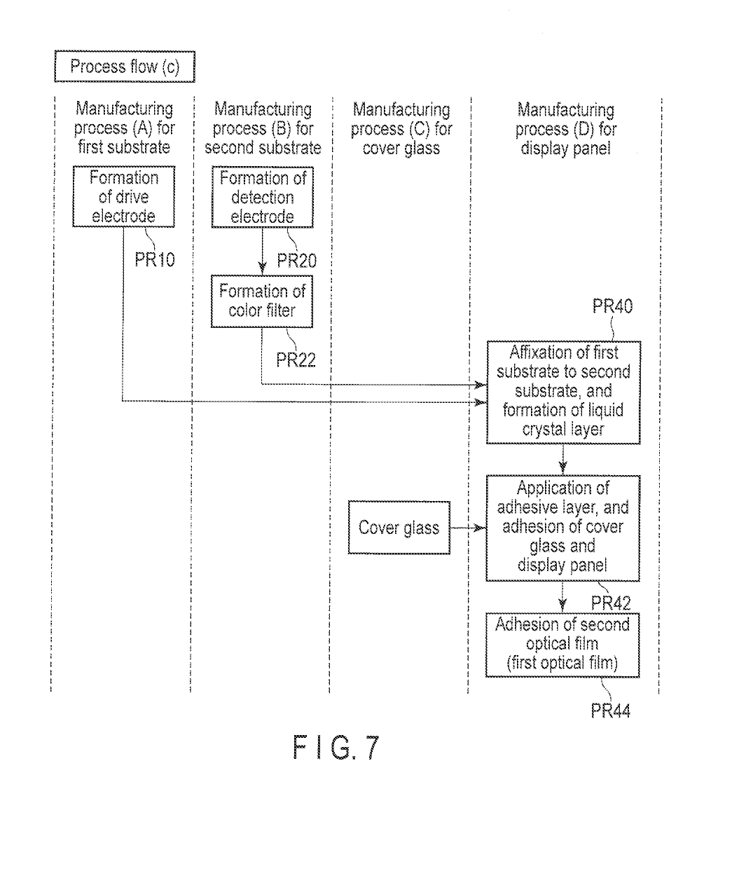

FIG. 7 is a diagram showing the process flow (c) for manufacturing the display device DSP having the cross section shown in FIG. 2 (c).

As compared to the process flow (a) shown in FIG. 5, process flow (c) differs in that the conductive adhesive layer GL is applied in process PR42 in the manufacturing process (D) of the display panel PNL in place of the formation of the antistatic layer AS in the process PR30 of the manufacturing process (C) of the cover glass CG. That is, in the process flow (c), it is desirable that an antistatic layer AS be not formed but for the adhesive layer GL have a function equivalent to that of the antistatic layer AS.

Note that the adhesive layer GL may be applied either to the surface C of the cover glass CG or to the detection electrode RX of the display panel PNL in the process PR42.

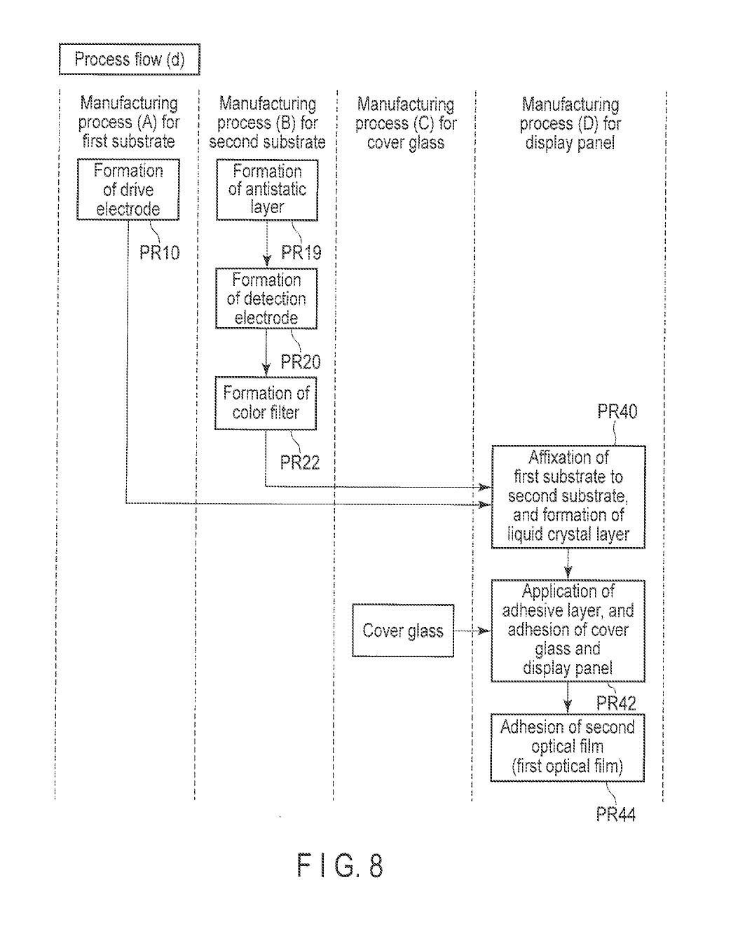

FIG. 8 is a diagram showing process flow (d) for manufacturing a display device DSP having the cross section shown in FIG. 2 (d).

As compared to the process flow (a) shown in FIG. 5, process flow (d) differs in that the formation of the antistatic layer AS in the process PR19 is carried out in the manufacturing process (B) of the second substrate SUB2, in place of the formation of the antistatic layer AS in process PR30 in the manufacturing process (C) of the cover glass. As to the method of forming the antistatic layer AS in process PR21, the process PR30 of FIG. 5 described above should be referred to. The process PR19 is performed before the process PR20. That is, the antistatic layer AS is formed on the surface B of the display panel PNL and the detection electrode RX is formed on the antistatic layer AS.

Note that the adhesive layer GL may be applied either to the surface C of the cover glass CG or the detection electrode RX of the display panel PNL in process PR42.

As described above, according to this embodiment, a display device which can suppress degradation of display quality while avoiding scattering of cover glass, can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A display device comprising:
a display panel comprising a first surface and a second surface on an opposite side to the first surface, configured to display an image on the second surface;
a cover glass comprising a third surface and a fourth surface on an opposite side to the third surface, the third surface facing the second surface of the display panel;
an adhesive layer configured to fix the display panel and the cover glass to each other; and
an optical film fixed to the fourth surface of the cover glass.

2. The display device of claim 1, wherein
the display panel comprises a first substrate, a second substrate opposing the first substrate and a liquid crystal layer held between the first substrate and the second substrate, and
the optical film comprises a polarizer.

3. The display device of claim 2, wherein
the first substrate comprises a pixel electrode provided for every pixel on a side opposing the second substrate, a common electrode opposing a plurality of pixel electrodes, and an interlayer insulating film interposed between the pixel electrodes and the common electrode.

4. The display device of claim 1, further comprising a detection electrode between the display panel and the cover glass, configured to detect an object approaching or contacting the optical film.

5. The display device of claim 1, further comprising an antistatic layer between the display panel and the cover glass.

6. The display device of claim 5, wherein
the antistatic layer is formed on the second or third surface.

7. The display device of claim 1, wherein the adhesive layer is an antistatic layer.

8. The display device of claim 5, wherein the antistatic layer has a sheet resistance of 10⁸Ω/□ or more.

9. The display device of claim 1, further comprising a detection electrode configured to detect an object approaching or contacting the optical film, and an antistatic layer, between the display panel and the cover glass,
wherein more, the detection electrode has a sheet resistance value of 1/100 or less of that of the antistatic layer.

10. The display device of claim 1, wherein the cover glass is formed from untempered glass.
